(19) United States
(12) Patent Application Publication
(10) Pub. No.: US 2012/0054392 A1
(43) Pub. Date: Mar. 1, 2012

(54) DATA READ AND WRITE DEVICE AND METHOD FOR USB PORTS OF 1-WIRE DEVICES

(75) Inventor: SHENG-YI LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/095,878

(22) Filed: Apr. 28, 2011

(30) Foreign Application Priority Data
Aug. 31, 2010 (CN) 201010268115.0

(51) Int. Cl. G06F 13/00

(52) U.S. Cl. 710/110

(57) ABSTRACT

A data read and write device for a USB port of a 1-Wire device includes a USB interface and a 1-wire host. The USB interface includes a USB buffer and a USB connector, and converts a USB command sent by a host computer to a 1-Wire command. The USB buffer is installed in a microcontroller, and the USB connector is connected to the host computer. The 1-Wire host includes a group of DIO pins and a connector connected to the microcontroller. The 1-wire host controls one of the DIO pins to transfer the 1-Wire command to a 1-Wire slave, receives feedback data of the 1-Wire slave, and temporarily storing the feedback data into the USB buffer. The microcontroller sends the feedback data to the host computer.

### BACKGROUND

1. Technical Field

Embodiments of the present disclosure generally relate to data read and write devices and methods, and more particularly to a data read and write device and method for a USB port of a 1-wire device.

2. Description of Related Art

Integrated circuits (ICs) are more expensive when they have more pins. To reduce the number of pins in a package, many ICs use a serial bus to transfer data when speed is not important. Some examples of such low-cost serial buses include Serial Peripheral Interface (SPI) bus, I²C, Scalable Coherent Interface (SCI), and 1-Wire. Because they provide low-speed data, signaling, and power over a single signal, the 1-Wire is typical used to communicate with small inexpensive devices such as digital thermometers and weather instruments. However, it is difficult to test a 1-Wire device because the 1-Wire device does not have a read and write tool.

### BRIEF DESCRIPTION OF THE DRAWINGS

FIG. 1 is a schematic diagram of one embodiment of a data read and write device for a USB port of a 1-wire device communicating with a host computer and a 1-wire slave.

FIG. 2 is a schematic diagram of one embodiment of the data read and write device included in FIG. 1.

FIG. 3 is a circuit diagram of one embodiment of a Microcontroller.

FIG. 4 is a circuit diagram of one embodiment of a switch included in a voltage regulator.

FIG. 5 is a circuit diagram of one embodiment of voltage conversion of the voltage regulator.

FIG. 6 is a flowchart illustrating one embodiment of a data read and write method for a USB port of a 1-wire device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

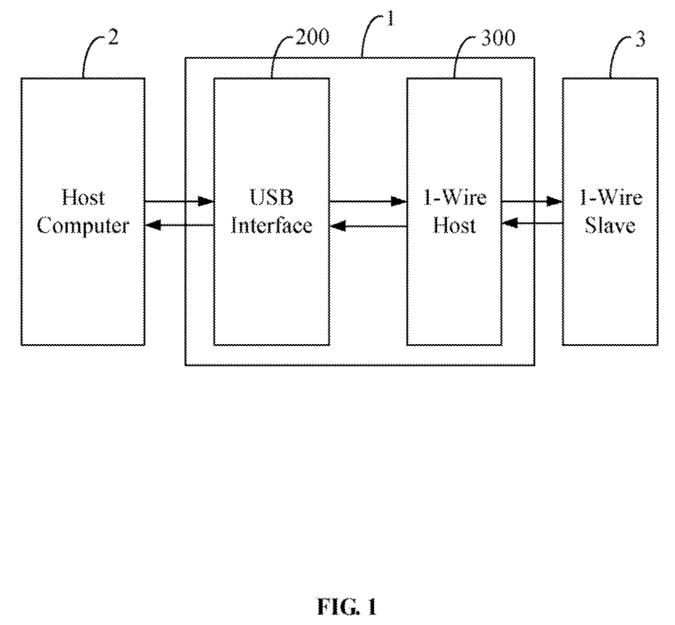

FIG. 1 is a schematic diagram of one embodiment of a data read and write device for a USB port of a 1-wire device (hereinafter referred to as “the data read/write device 1”). In the embodiment, the data read/write device 1 includes a USB interface 200, and a 1-wire host 300 connected to the USB interface 200. The USB interface 200 can receive USB commands from a host computer 2. In the embodiment, the USB commands represent data with a USB transfer format. The USB interface 200 converts the USB commands into 1-wire commands In the embodiment, the 1-wire commands represents data having a 1-wire transfer format and can be transferred through 1-wire buses. The 1-wire host 300 transfers the 1-Wire commands to a 1-Wire slave 3. The 1-wire host 300 receives feedback data of the 1-Wire slave 3 according to the 1-wire commands, and the USB interface 200 transmits the feedback data to the host computer 2. In one embodiment, the 1-wire slave 3 is an electronic device that can transmit data using the 1-wire buses.

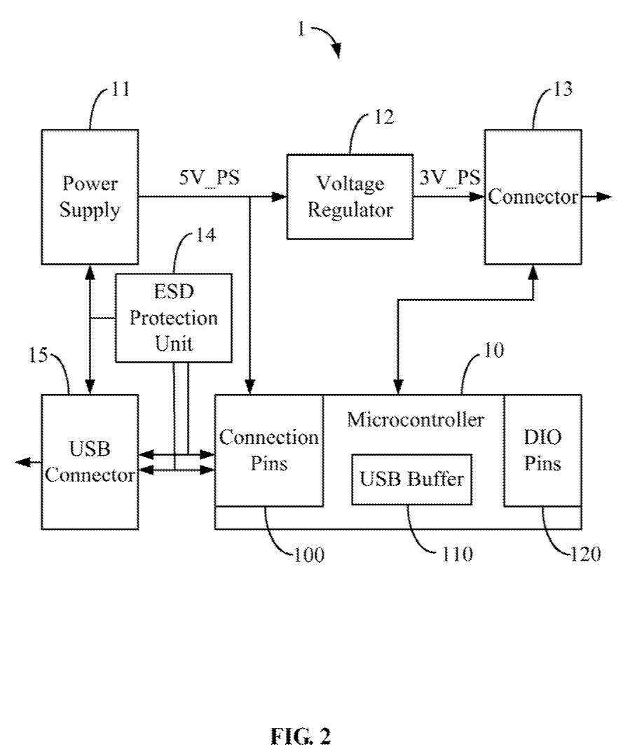

FIG. 2 is a schematic diagram of one embodiment of the data read/write device 1 including in FIG. 1. As illustrated in FIG. 1, the data read/write device 1 includes the USB interface 200 and the 1-wire host 300. The USB interface 200 includes a microcontroller 10, and the microcontroller 10 has a group of connection pins 100 and a group of input/output data (DIO) pins 120. The connection pins 100 connect with a power supply 11, a voltage regulator 12, a connector 13, an Electro-Static Discharge (ESD) protection unit 14, and a USB connector 15. The USB connector 15 may be a USB 2.0 cable or a USB 1.1 cable.

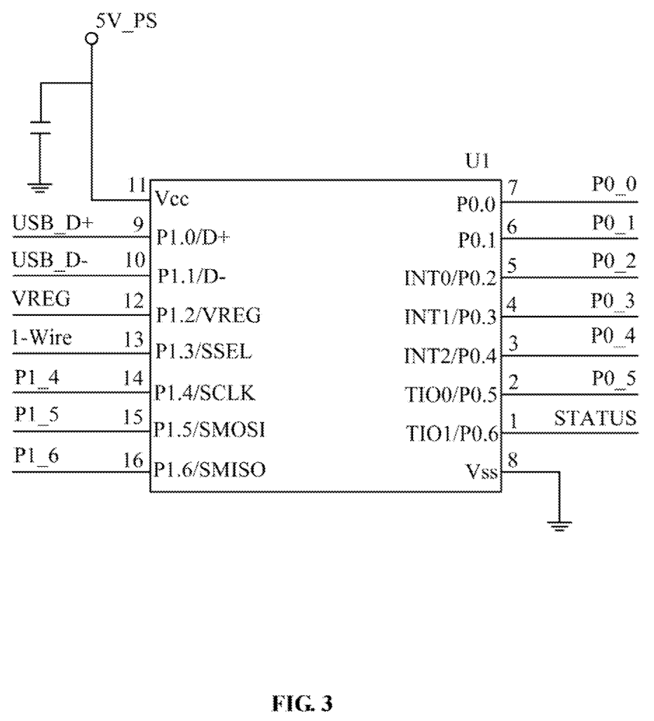

As shown in FIG. 3, the DIO pins 120 may be denoted as P0.0-P0.6 and P1.0-P1.6, and each of the DIO pins 120 can input and output data from the microcontroller 10. The DIO pins 120 can also be used for extending functions of the data read/write device 1, for example, indicating lamp control, switch control, or status detection of the read/write device 1. The 1-wire host 300 includes the connector 13 and the DIO pins 120.

In the embodiment, the data read/write device 1 is connected to the 1-wire slave 3 via the connector 13, and is connected to the host computer 2 via the USB connector 15. The microcontroller 10 further includes a USB buffer 110 that stores the data transferred between the 1-wire slave 3 and the host computer 2, such as feedback data from 1-wire slave 3, for example.

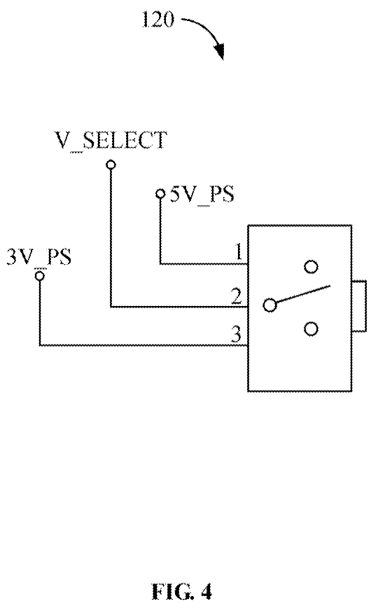

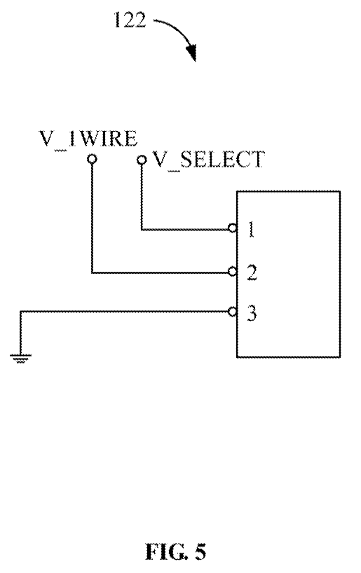

In the embodiment, the power supply 11 provides a first voltage to the USB interface 200. The voltage regulator 12 transmits the first voltage to the connector 13. As illustrated in FIG. 4 and FIG. 5, the voltage regulator 12 includes a switch 120 and a voltage conversion circuit 122. Upon the condition that the switch 120 is turned to convert the first voltage, the voltage conversion circuit 122 converts the first voltage into a second voltage, and transmits the second voltage to the connector 13. Upon the condition that the switch 120 is not turned to convert the first voltage, the voltage conversion circuit 122 transmits the first voltage to the connector 13. In the embodiment, the connector 13 connects the 1-wire slave 3 via a 1-wire bus. The first voltage may be about five volts, and the second voltage may be about three volts.

When the host computer 2 sends a USB command to the data read/write device 1 via the USB connector 15, the microcontroller 10 receives the USB command, and converts the USB command to a 1-wire command.

The 1-wire host 300 controls one of the DIO pins 120 to simulate the 1-wire bus, to transfer the 1-Wire command to the 1-Wire slave 3 that is connected to the connector 13. After receiving the 1-wire command, the 1-wire slave 3 may feedback data to the microcontroller 10. The 1-wire host 300 receives the feedback data, and temporarily stores the feedback data into the USB buffer 110. And then the microcontroller 10 sends the feedback data to the host computer 2.

In the embodiment, one terminal of the ESD protect unit 14 is electrically connected to the microcontroller 10 and the USB connector 15, and the other terminal of the ESD protect unit 14 is electrically connected to the power supply 11 and the voltage regulator 12. The ESD protect unit 14 is used for performing overvoltage protection on the microcontroller 10 and the USB connector 15.

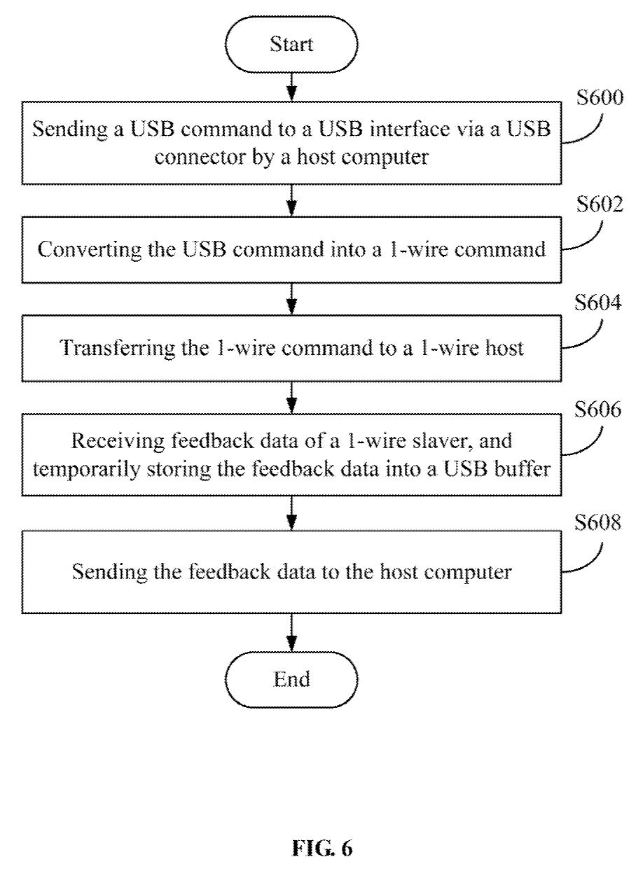

FIG. 6 is a flowchart illustrating one embodiment of a data read and write method for a USB port of a 1-wire device. Depending on the embodiment, additional blocks may be added, others removed, and the ordering of the blocks may be changed.

In block 5600, the host computer 2 sends a USB command to the USB interface 200 via the USB connector 15. In the embodiment, the USB command represents data having a USB transfer format.

In block 5602, the microcontroller 10 converts the USB command to a 1-wire command, and transmits the 1-wire command to the 1-wire host 300. In one embodiment, the 1-wire command represents data having a 1-wire transfer format and can be transferred through 1-wire buses.

In block 5604, the 1-wire host 300 controls one of the DIO pins 120 of the microcontroller 10 to simulate the 1-wire bus, to transfer the 1-Wire command to the 1-Wire slave 3 that is connected to the connector 13 via the 1-wire bus. After receiving the 1-wire command, the 1-wire slave 3 may feedback data to the microcontroller 10.

In block 5606, the 1-wire host 300 receives the feedback data from the 1-wire slave 3, and temporarily stores the feedback data into the USB buffer 110.

In block 5608, the microcontroller 10 sends the feedback data to the host computer 2 via the USB connector 15.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A data read and write device for a USB port of a 1-Wire device, the data read and write device comprising:
a USB interface comprising a microcontroller and a USB connector, the microcontroller comprising a USB buffer, and the USB connector connected to a host computer, the USB interface configured to convert a USB command sent by the host computer to a 1-Wire command; and
a 1-Wire host, comprising a group of data input-output (DIO) pins and a connector connected to the microcontroller, to control one of the DIO pins to transfer the 1-Wire command to a 1-Wire slave that is connected to the connector, receive feedback data of the 1-Wire slave, temporarily store the feedback data into the USB buffer; and
the microcontroller to send the feedback data to the host computer.

2. The data read and write device as claimed in claim 1, wherein the USB interface further comprises:
a power supply to provide a first voltage to the USB interface;
a voltage regulator to transmit the first voltage to the connector of the 1-wire host; and
an ESD protect unit to perform overvoltage protection on the microcontroller and the USB connector, wherein one terminal of the ESD protect unit is electrically connected to the microcontroller and the USB connector, and the other terminal of the ESD protect unit is electrically connected to the power supply and the voltage regulator.

3. The data read and write device as claimed in claim 2, wherein the voltage regulator comprises a switch and a voltage conversion circuit.

4. The data read and write device as claimed in claim 3, wherein the voltage conversion circuit is configured to convert the first voltage into a second voltage transmitted to the connector of the 1-wire host upon the condition that the switch is turned to convert the first voltage, or transmit the first voltage to the connector of the 1-wire host upon the condition that the switch is not turned to convert the first voltage.

5. The data read and write device as claimed in claim 1, wherein the DIO pins are further configured for extending functions of the read and write device, the functions comprise indicating lamp control, switch control, and status detection of the read and write device.

6. A data read and write method for a USB port of a 1-Wire device, the method comprising:
sending a USB command to a USB interface via a USB connector by a host computer;
converting the USB command to a 1-wire command by the USB interface, and transmitting the 1-wire command to a 1-wire host;
controlling a data input-output (DIO) pin of the 1-wire host to transfer the 1-Wire command to a 1-Wire slave that is connected to a connector of the 1-wire host;
reading feedback data of the 1-Wire slave and temporarily storing the feedback data into a USB buffer of the USB interface by the 1-wire host; and
sending the feedback data to the host computer by the USB interface.

7. The method as claimed in claim 6, wherein the USB interface comprises:
a power supply to provide a first voltage to the USB interface;
a voltage regulator to transmit the first voltage to the connector of the 1-wire host; and
an ESD protect unit to perform overvoltage protection on a microcontroller and the USB connector, wherein one terminal of the ESD protect unit is electrically connected to the microcontroller and the USB connector, and the other terminal of the ESD protect unit is electrically connected to the power supply and the voltage regulator.

8. The method as claimed in claim 7, further comprising:
converting the first voltage into a second voltage transmitted to the connector of the 1-wire host upon the condition that a switch of the voltage regulator is turned to convert the first voltage; or
transmitting the first voltage to the connector of the 1-wire host upon the condition that the switch is not turned to convert the first voltage.

9. The as claimed in claim 8, wherein the first voltage is about five volts, and the second voltage is about three volts.
